(19) United States
(12) Patent Application Publication
(10) Pub. No.: US 2005/0265350 A1
(43) Pub. Date: Dec. 1, 2005

(54) Concurrent packet data session set-up for push-to-talk over cellular

(76) Inventors: Murali Narasimha, Grayslake, IL (US); Alberto Gutierrez, Buffalo Grove, IL (US)

Correspondence Address: MOTOROLA INC, 600 NORTH US HIGHWAY 45, ROOM AS437, LIBERTYVILLE, IL, 60048-5343, US

(21) Appl. No.: 10/857,243

(22) Filed: May 28, 2004

(51) Int. Cl. H04L 12/56

(52) U.S. Cl. 370/395.2

(57) ABSTRACT

This concurrent packet data session set-up for Push-to-talk over Cellular (PoC) services decreases the connection set-up time for a PoC call by using processes that are circuit-switched-based to locate and page a called communication device, and to initiate traffic and packet data session set-ups for the called communication device. A method for setting up a packet data session between an originating communication device (211) and a called communication device (215) includes the steps of: requesting a called-device active packet data session set-up for the called communication device (messages 271, 272, 273, 274, 275) and initiating an originating-device active packet data session set-up for the originating communication device (messages 271, 222, 224). The first step can use circuit-switched-based messages and processes to locate the called communication device and set up a traffic channel for the called communication device. After an active packet data session (263) is set-up for the originating communication device (211), the originating-device active packet data session (263) can be used to request a PoC voice channel (message 290). Because a called-device active packet data session set-up has already been requested, the called communication device (215) can respond to the PoC voice channel request quickly (message 293).

### FIELD OF THE DISCLOSURE

This disclosure relates generally to push-to-talk (PTT) service in a cellular telephone communication system, and more particularly to reducing call set-up delay in certain PTT over Cellular (PoC) connection set-ups.

### BACKGROUND OF THE DISCLOSURE

Push-to-talk (PTT) refers to a half-duplex mode of communication during which a single user has mutually exclusive use of a communication channel for the transmission of voice information to another user or group of users. From an operational viewpoint, an originating party presses a PTT switch on a mobile device, possibly awaits a “ready” tone, speaks into a microphone of the mobile device, and then releases the PTT switch. At this point, a former called party can press a PTT switch on his own mobile device, possibly await a “ready” tone, speak into the microphone, and release the PTT switch. This procedure is repeated with different parties becoming the originating user and transmitting to one or more called parties until the conversation has completed.

PTT service avoids the typical dialing and ringing sequence of standard telephony service and thus is quicker than standard telephony service. There is a time delay, however, between the moment that a user initiates PTT service (usually indicated by pressing a PTT switch) and the moment a PTT circuit is set up (usually indicated by a “ready” tone). This time delay, known as the PTT call set-up delay, is a critical parameter for PTT services. If the call set-up delay is larger than an originating user expects, the user may forget to wait for the “ready” tone and, instead, talk before the PTT traffic channel is set up. Talking before the PTT traffic channel is set up results in called users failing to hear at least part of the voice communications from the originating user, which results in an unfavorable user experience.

Because PTT service avoids the dialing and ringing sequence, users often assume that PTT set-up should be faster than standard telephony set-up. Unfortunately, PTT over Cellular (PoC) circuit set-up generally takes longer than standard telephony set-up in a cellular system. This is because PTT services in the cellular domain use conventional and already-deployed technology and infrastructure, which is not optimized for fast PTT connection set-up. Instead, PoC relies on conventional cellular techniques for PTT connection set-up. Given that a packet data session needs to be established among the members of a PTT group, the connection set-up time of a typical PoC call is currently 6.5-10 seconds. Thus, there is an opportunity to reduce the average PTT call set-up delay for PTT circuit set-up under certain conditions.

The various aspects, features and advantages of the disclosure will become more fully apparent to those having ordinary skill in the art upon careful consideration of the following Drawings and accompanying Detailed Description.

### BRIEF DESCRIPTION OF THE DRAWINGS

FIG. 1 shows a Third Generation (3G) Code Division Multiple Access (CDMA 1x) system architecture with push-to-talk (PTT) capabilities according to a preferred embodiment.

FIG. 2 shows a sample signal flow diagram for setting up a push-to-talk call over the Third Generation (3G) Code Division Multiple Access (CDMA 1x) system shown in FIG. 1 according to the preferred embodiment.

FIG. 3 shows a flow chart for processing, according to the preferred embodiment, a Push-to-talk over Cellular (PoC) call at the originating communication device's base station controller in the CDMA 1x system shown in FIG. 1.

FIG. 4 shows a flow chart for processing, according to the preferred embodiment, a PoC call at the originating communication device's mobile switching center in the CDMA 1x system shown in FIG. 1.

FIG. 5 shows a flow chart for processing, according to the preferred embodiment, a PoC call at the called communication device's mobile switching center in the CDMA 1x system shown in FIG. 1.

FIG. 6 shows a flow chart for processing, according to the preferred embodiment, a PoC call at the called communication device's base station controller in the CDMA 1x system shown in FIG. 1.

### DETAILED DESCRIPTION OF THE PREFERRED EMBODIMENTS

This concurrent packet data session set-up for Push-to-talk over Cellular (PoC) services decreases the connection set-up time for a PoC call by using processes that are circuit-switched-based to locate and page a called communication device, and to initiate traffic and packet data session set-ups for the called communication device. A method for setting up a packet data session between an originating communication device and a called communication device includes the steps of: (1) requesting a called-device active packet data session set-up for the called communication device; and (2) initiating an originating-device active packet data session set-up for the originating communication device. The first step can use circuit-switched-based messages and processes to locate the called communication device and set up a traffic channel for the called communication device. After an active packet data session is set-up for the originating communication device, the originating-device active packet data session can be used to request a PoC voice channel. Because a called-device active packet data session set-up has already been requested, the called communication device can respond to the PoC voice channel request quickly.

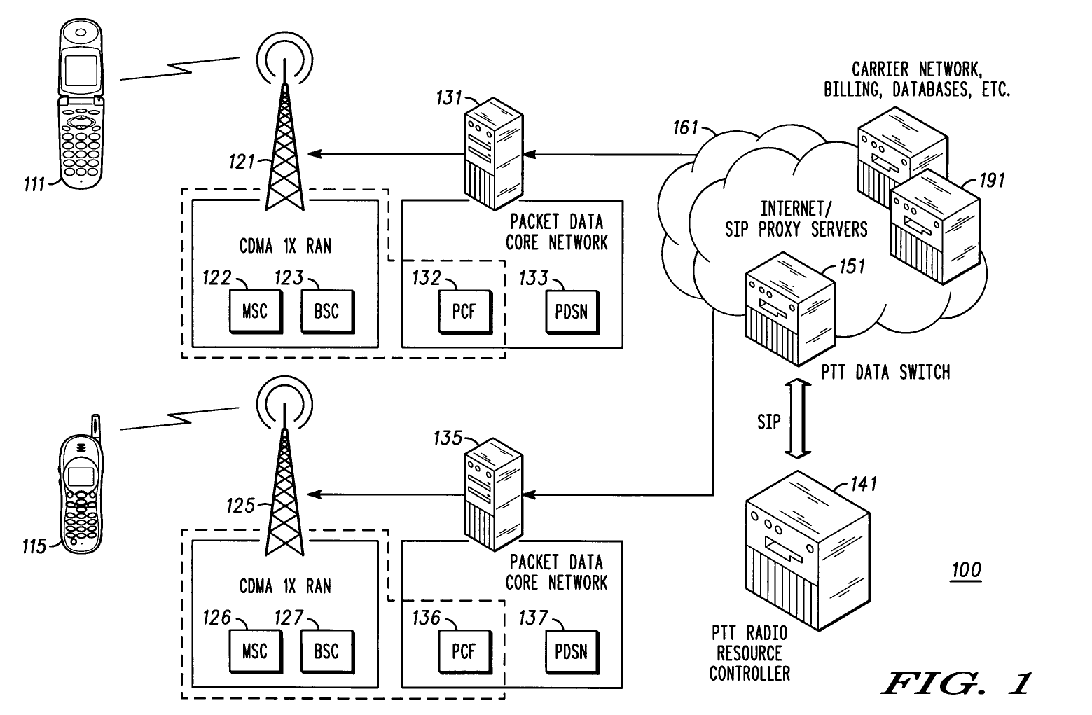

FIG. 1 shows a Third Generation (3G) Code Division Multiple Access (CDMA 1x) system architecture with push-to-talk (PTT) capabilities according to a preferred embodiment. Although this preferred embodiment is a CDMA 1x system, a GSM/GPRS system can be substituted using the concepts disclosed in this patent application to produce different messages between the various GSM system components (e.g., gateway GPRS support nodes and serving GPRS support nodes, etc.). Additionally, wireless local access network (WLAN) technology, as well as hybrids, blends, and future evolutions of communication technologies, can use the concepts disclosed in this patent application, especially with the voice-over-IP protocol architecture.

In this PTT system 100, an originating communication device 111 wirelessly communicates with a radio access network 121. This radio access network 121 connects to a packet data core network 131 which in turn connects to a PTT radio resource controller 141 (sometimes called a PTT radio resource manager) and a PTT data switch 151 (sometimes called a PTT server) through the Internet 161. Other elements 191, such as the carrier network, billing servers, databases, and other equipment are also coupled to the Internet 161.

In this example, a called communication device 115 wirelessly communicates with a different radio access network 125. The radio access network 125 connects to a packet data core network 135, which in turn uses an Internet Protocol (IP) to connect to the PTT radio resource controller 141 and PTT data switch 151 through the Internet 161. Of course, the called communication device 115 can be served by the same radio access network as the originating communication device 111.

For the purposes of providing detail for this preferred embodiment, the communication devices 111, 115 are shown as wireless CDMA 1x telephone user equipment, although one or more communication devices could be implemented as another type of wireless communication device such as a personal digital assistant, a pocket personal computer, or a laptop computer. Additionally, the communication device can be a wired device such as a landline telephone, a desktop computer, or a cable modem. Because in this embodiment the communication devices are CDMA 1x user equipment, the radio access networks 121, 125 are CDMA 1x radio access networks; however, alternate radio access networks such as WLAN, CDMA2000, and GSM/GPRS are available for appropriately compatible communication devices.

The radio access networks 121, 125 each include a base station controller (BSC) 123, 127 and a mobile switching center (MSC) 122, 126, which assist in circuit-switched session set-up. The radio access networks connect to packet data core networks 131, 135, that each include a packet control function (PCF) 132, 136 and a Packet Data Serving Node (PDSN) 133, 137, which assist in packet data session set-up. Note that, although a PCF is conceptually part of a packet data core network, the physical location of a PCF implementation is usually with a MSC and BSC in a radio access network. The packet data core networks 131, 135 in turn connect to the PTT radio resource controller 141 and PTT data switch 151 through the Internet 161.

When the originating communication device 111 is operated for a PoC call, a signal goes from the communication device 111 to various elements of the radio access network 121 to set up a traffic channel between the communication device 111 and its serving radio access network 121. After the originating-device traffic channel is set up, an active packet data session is set up between the communication device 111 and the packet data core network 131. Concurrently with this set up of the originating-device traffic channel and active packet data session, the radio access network 121 of the originating communication device 111 uses cellular functionality to page the radio access network 125 of the called communication device 115 and set up a traffic channel between the called communication 115 and its serving radio access network 125. After the called-device traffic channel is set up, the called communication device 115 sets up a packet data session with its packet data core network 135.

Thus, when the packet data session for the originating communication device 111 is active, and the originating communication device 111 sends a message to the PTT data switch 151 requesting the floor, the PTT data switch 151 can forward the request to a radio access network 125 that is already in the process of (or has completed the process of) establishing a traffic channel and an active packet data session with the called communication device 115. Then, the PoC connection request can quickly be forwarded to the called communication device 115, the called communication device can quickly respond, and the PoC call set-up delay is reduced.

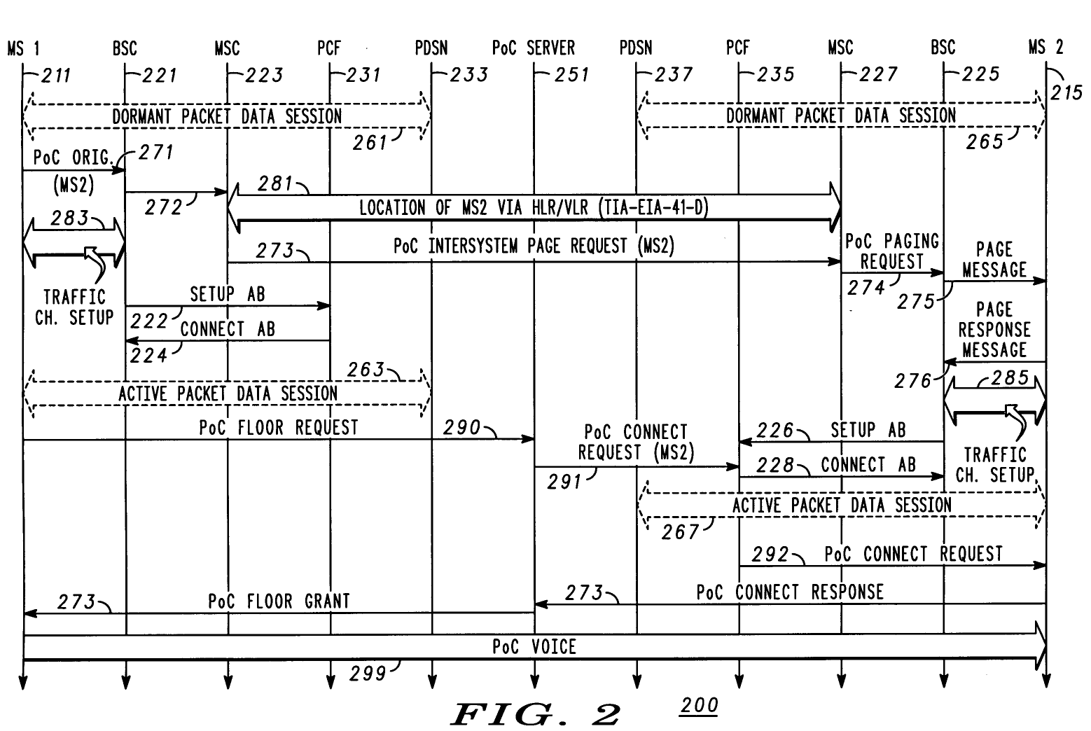

FIG. 2 shows a sample signal flow diagram 200 for setting up a push-to-talk call over the Third Generation (3G) Code Division Multiple Access (CDMA 1x) system 100 shown in FIG. 1 according to the preferred embodiment. Vertical line 211 represents signaling to and from an originating communication device (MS1), such as communication device 111 shown in FIG. 1. Vertical line 221 represents signaling to and from a base station controller (BSC), which can be implemented as a component of a radio access network such as the CDMA 1x radio access network 121 shown in FIG. 1. Vertical line 223 represents signaling to and from a mobile switching center (MSC), which can be implemented as a component of a radio access network such as the CDMA 1x radio access network 121 shown in FIG. 1. Vertical line 231 represents signaling to and from a packet control function (PCF), which can be implemented as a component of a radio access network, such as the RAN 121 shown in FIG. 1. Vertical line 233 represents signaling to and from a packet data serving node (PDSN), which can be implemented as a component of a packet data core network such as the packet data core network 131 shown in FIG. 1. Vertical line 251 represents signaling to and from a PTT-over-Cellular (PoC) server, which can be implemented as the PTT data switch 151 shown in FIG. 1.

Vertical line 237 represents signaling to and from a packet data serving node (PDSN) associated with a called communication device (MS2), which can be implemented as a component of a packet data core network such as the packet data core network 135 shown in FIG. 1. Vertical line 235 represents signaling to and from a packet control function (PCF) of the called communication device (MS2), which can be implemented as a component of a packet data core network such as the packet data core network 135 shown in FIG. 1. Vertical line 227 represents signaling to and from a mobile switching center (MSC), which can be implemented as a component of a radio access network such as the CDMA 1x radio access network 125 shown in FIG. 1. Vertical line 225 represents signaling to and from a base station controller (BSC) of the called communication device (MS2), which can be implemented as a component of a radio access network such as the CDMA 1x radio access network 125 shown in FIG. 1. Vertical line 215 represents signaling to and from the called communication device (MS2), such as the communication device 115 shown in FIG. 1.

Initially, both the originating communication device (MS1) and the called communication device (MS2) are in dormant states 261, 265 where the devices are registered with their associated packet data core network but there is no active traffic channel between each communication device and its associated radio access network. When a user presses a PTT switch to request service for a one-to-one PoC call, a PoC origination message 271 is sent from the originating communication device 211 to the BSC 221 requesting a PTT session with a single called communication device. As described below, one-to-many PoC calls can be handled using multiple PoC origination messages (not shown) or a single PoC origination message with multiple identifications (not shown).

The PoC origination message 271 is used to indicate to the BSC 221 that the originating communication device MS1 desires to establish an active packet data connection specifically for a PoC call. In this preferred embodiment, the active packet data session is governed by the Service Option 33 (SO33) protocol. Of course, other packet data protocols can be used, especially as technology progresses. In addition to the current SO33 origination message information as specified in IS-2000-5 for CDMA 1x systems, this message 271 includes fields for (1) an indication that the PoC origination is for a PoC connection and (2) an identification of the called communication device (MS2). The identification could be a mobile identification number (MIN), an International Mobile Station Identity (IMSI), directory number, or other type of identification for the communication device. By sending multiple PoC origination messages, each specifying a single called communication device, this method can be used to set up group (one-to-many) PoC calls. Alternately, a single PoC origination message can include multiple identifications in field (2), which identifications can be separated into multiple messages during the next step described below. This PoC origination message 271 is relayed as a PoC origination indication message 272 from the BSC 221 to the MSC 223. (If there are multiple identifications in the PoC origination message 271, there will be multiple PoC origination indication messages 272—each with a single identification.) At step 281, the cellular network uses known methods to locate the serving MSC of the called communication device MS2 via home location registers and visitor location registers (HLR/VLR). Known methods include the TIA-EIA-41-D standard for 3G cellular systems. After the serving cell of the called communication device is located, the MSC 223 sends a PoC intersystem page request message 273 to the MSC 227 of the called communication device MS2. The PoC intersystem page request message 273 is used to indicate to the target MSC 227 that the called communication device MS2 needs to be paged for a PoC connection. (This message 273 is not necessary if the originating communication device MS1 and the called communication device MS2 are both associated with the same MSC.) In addition to having the information in the intersystem page message specified in TIA/EIA-41-D, this message 273 includes a field for indicating whether the page is for a PoC connection. Thus, the intersystem page message has an identification parameter to identify a called communication device, a location parameter to specify a paging area for the called communication device, an MSCID parameter to identify the originating mobile switching center, and a PoC parameter for indicating whether the message is for a PoC connection.

The MSC 227 sends a PoC paging request message 274 to the BSC 225 of the called communication device MS2. This PoC paging request message 274 is used by the target MSC 227 to indicate to the serving BSC 225 that the called communication device MS2 should be paged for a PoC connection. In addition to the paging request contents specified as part of the A-1 interface in IS-2001, this message 274 includes fields for (1) an indication that the page is for a PoC connection and (2) an identification of the called communication device MS2.

Upon receipt of the PoC Paging request message 274, the BSC 225 sends a packet data page message 275 requesting a packet data connection for the called communication device 215. In this preferred embodiment, the active packet data session is governed by the SO33 protocol, but the SO33 protocol can easily be supplanted by another packet data protocol. The called communication device 215 responds with a page response message 276 indicating that it is available for a packet data session. Upon receipt of a page response message 276, the BSC 225 conducts a traffic channel set-up 285 with the communication device 215. After the traffic channel is set up, the BSC 225 and the PCF 235 use a packet data session set-up message 226 and a packet data session set-up connect message 228 to set up an active packet data session 267.

Meanwhile, the originating communication device 211 and its serving BSC 221 are setting up a traffic channel 283. After the traffic channel 283 is set up, the BSC 221 and PCF 231 set up an active packet data connection using messages 222 and 224. According to this embodiment, the active packet data connection set-up is in accordance with the A8 protocol. After the active packet data connection is set up, the originating communication device MS1 is in an active packet data session 263. At this point, the communication device 211 sends a PoC floor request message 290 to the PoC server 251. The PoC server 251 sends a PoC connection request message 291 to the PCF 235 of the called communication device MS2. Note that messages 222, 224, and 290 are being sent and acted upon concurrently with the various PoC paging messages 273, 274, 275, 276, the traffic channel set-up 285 for the called communication device MS2, and the active SO 33 packet data session set-up messages 226, 228 for the called communication device MS2.

After the active packet data session 267 is set up for the called communication device MS2 (which can occur before or after the PoC connect request message 291 reaches the called PCF 235), the PCF 235 forwards a PoC connection request message 292 to the called communication device 215. The called communication device 215 responds with a PoC connection response message 293 to the PoC server 251, which is relayed to the communication device 211 as a PoC floor grant message 294. At this point, the user of the originating communication device 211 can send a half-duplex voice communication using a PoC voice channel 299.

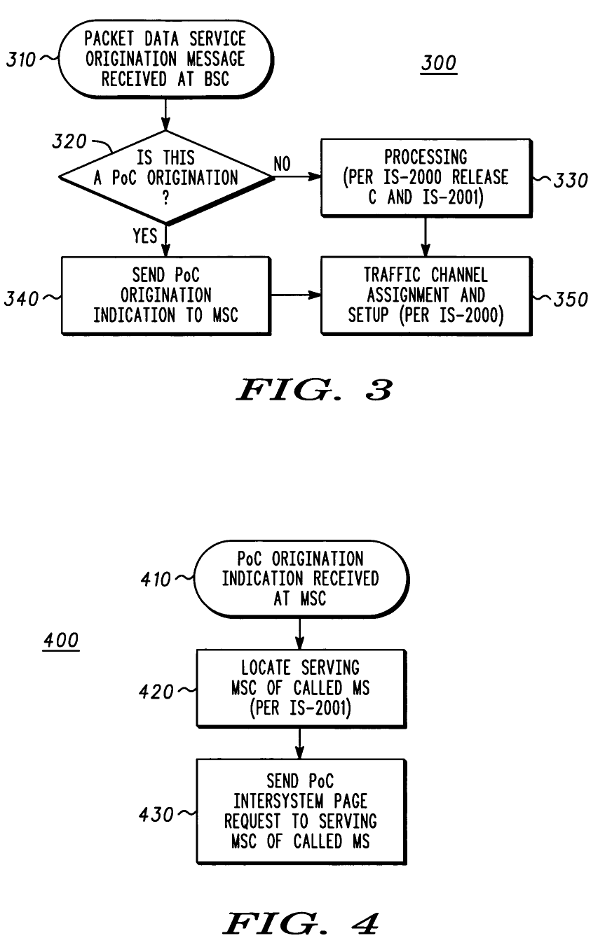

FIG. 3 shows a flow chart 300 for processing, according to the preferred embodiment, a Push-to-talk over Cellular (PoC) call at the originating communication device's base station controller 123 in the CDMA 1x system 100 shown in FIG. 1. In the initial step 310, the base station controller receives a packet data service origination message. This message could be a conventional packet data service origination message or a PoC origination message (such as message 271 in FIG. 2) that requests an active packet data session specifically for a PoC call. Step 320 determines whether the received packet data service origination message was a PoC origination message, based on an indication in the packet data service origination message. If the message was not a PoC origination message, the process goes to step 330 where the base station controller processes the message according to existing cellular standards, such as IS-2000 release C and IS-2001 for CDMA 1x communications. Step 350 then performs conventional traffic channel assignment and setup such as per IS-2000 for CDMA 1x communications.

Returning to step 320, if the message received is a PoC origination message, step 340 sends a PoC origination indication message to the mobile switching center (message 272 in FIG. 2) before going to step 350 and performing conventional traffic channel assignment and setup, such as per IS-2000 for CDMA 1x communications.

FIG. 4 shows a flow chart 400 for processing, according to the preferred embodiment, a PoC call at the originating communication device's mobile switching center 122 in the CDMA 1x system 100 shown in FIG. 1. In the initial step 410, the mobile switching center receives a PoC origination indication message (message 272 in FIG. 2). Step 420 locates the serving MSC of the called communication device (step 281 in FIG. 2) using conventional methods, such as per IS-2001 for 3G communications. Step 430 then sends a PoC intersystem page request (message 273 in FIG. 2) to the serving MSC of the called communication device.

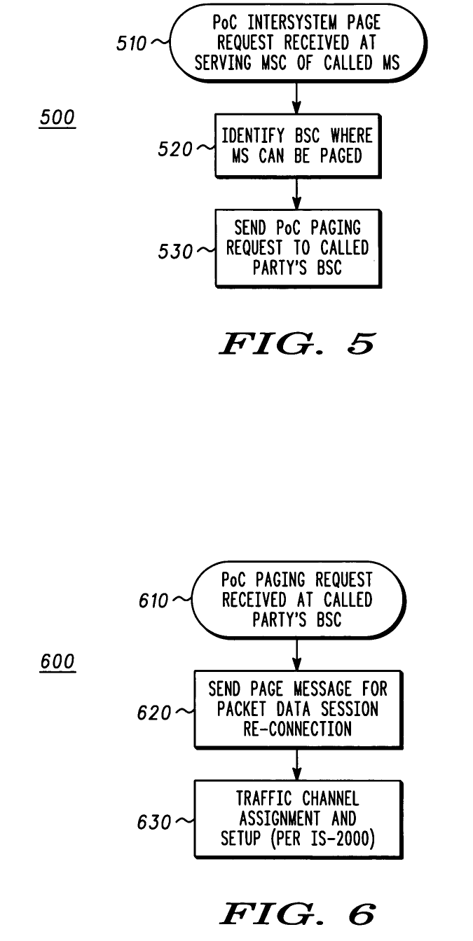

FIG. 5 shows a flow chart 500 for processing, according to the preferred embodiment, a PoC call at the called communication device's mobile switching center 126 in the CDMA 1x system 100 shown in FIG. 1. In the initial step 510, the mobile switching center of the called communication device receives a PoC intersystem page request message (message 273 in FIG. 2). Step 520 identifies the BSC or BSCs where the communication device can be paged. Step 530 sends a PoC paging request message (message 274 in FIG. 2) to the called party's BSC.

FIG. 6 shows a flow chart 600 for processing, according to the preferred embodiment, a PoC call at the called communication device's base station controller 127 in the CDMA 1x system 100 shown in FIG. 1. In the initial step 610, the base station controller of the called communication device receives a PoC paging request message (message 274 in FIG. 2). Step 620 sends a page message (message 275 in FIG. 2) for packet data session reconnection to the called communication device. Step 630 performs conventional traffic channel assignment and setup, such as per IS-2000 for CDMA communications.

Thus, in accordance with FIGS. 3-6, the base station controller serving the called communication device can be located and triggered to begin traffic channel assignment and setup even before an active packet data session occurs for the originating communication device.

Because a cellular circuit-switched protocol (such as a PoC intersystem page request message 273) is used to start the set-up of an active packet data session for a called communication device before an active packet data session set-up is completed for the originating communication device, the call set-up delay of a PTT call can be reduced by about 3250 ms. This technique allows concurrent reconnection of the PCF-to-communication device channel at both the originating and called communication devices of the PoC connection. This concurrent reconnection includes the air interface traffic channel set-up, which is generally the longest phase is such a reconnection. A generally long air interface traffic channel set-up delay is especially true for the called communication device, because it has to be located (paged) before a traffic channel set-up procedure can begin. This technique takes advantage of the optimization of cellular systems for circuit-switched connections. This technique takes the formerly sequential steps of traffic channel set-up for the originating communication device, packet data session set-up for the originating communication device, traffic channel set-up for the called communication device, and packet data session set-up for the called communication device, and the technique makes part of the traffic channel set-up and the active packet data session set-up for the originating device concurrent with the traffic channel set-up and the active packet data session set-up for the called communication device.

While this disclosure includes what are considered presently to be the preferred embodiments and best modes of the invention described in a manner that establishes possession thereof by the inventors and that enables those of ordinary skill in the art to make and use the invention, it will be understood and appreciated that there are many equivalents to the preferred embodiments disclosed herein and that modifications and variations may be made without departing from the scope and spirit of the invention, which are to be limited not by the preferred embodiments but by the appended claims, including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software, if any, will be limited in the interest of brevity and minimization of any risk of obscuring the principles and concepts according to the present invention.

1. A method for setting up a packet data session between an originating communication device and a called communication device comprising the steps of:
requesting a called-device active packet data session set-up for the called communication device; and
initiating, concurrently with the step of requesting, an originating-device active packet data session set-up for the originating communication device.

2. A method in accordance with claim 1, wherein the step of requesting a called-device traffic channel set-up comprises the step of:
locating the called communication device.

3. A method in accordance with claim 2, wherein the step of requesting a called-device traffic channel set-up further comprises the step of:
setting up a traffic channel for the called communication device.

4. A method in accordance with claim 3, wherein the step of requesting a called-device traffic channel set-up further comprises the step of:
setting up an active packet data session for the called communication device.

5. A method in accordance with claim 1, wherein the step of initiating a originating-device active packet data session set-up comprises the step of:
setting up a traffic channel for the originating communication device.

6. A method in accordance with claim 1, wherein the step of initiating a originating-device active packet data session set-up comprises the step of:
setting up an active packet data session for the originating communication device.

7. A method in accordance with claim 1 further comprising the step of:
completing the originating-device active packet data session set-up; and
using the originating-device active packet data session to request a push-to-talk over cellular (PoC) voice channel.

8. A method for setting up a packet data session between an originating communication device and a called communication device comprising the steps of:
sending a packet data origination message to a first radio access network serving the originating communication device;
setting up a first traffic channel and a first active packet data session for the originating communication device;
locating a second radio access network serving the called communication device, concurrently with the step of setting of a first traffic channel and a first active packet data session; and
setting up a second traffic channel and a second active packet data session for the called communication device.

9. A method in accordance with claim 8, wherein the packet data origination message indicates whether a Push-to-talk over Cellular (PoC) is being requested.

10. A method in accordance with claim 8, further comprising the step of:
sending a Push-to-talk over Cellular request message, after the step of setting up a first traffic channel and a first active packet data session.

11. A method in accordance with claim 10, further comprising the step of:
responding to the Push-to-talk over Cellular request message, after the step of setting up a second traffic channel and a second active packet data session.

12. A method for a base station controller comprising the steps of:
receiving a packet data service origination message;
determining if the packet data service origination message results from a Push-to-talk over Cellular service request; and
sending a Push-to-talk over Cellular (PoC) indication to a mobile switching center, if the packet data service origination message results from a PoC service request.

13. A method according to claim 12 further comprising the step of:
setting up a traffic channel, after the step of sending a PoC indication.

14. A Push-to-talk over Cellular (PoC) origination message comprising:
a PoC origination indicator; and
an identification for at least one called communication device.

15. A Push-to-talk over Cellular (PoC) intersystem page message comprising:
an identification parameter to identify a called communication device;
a location parameter to specify a paging area for the called communication device;
an MSCID parameter to identify an originating mobile switching center; and
a PoC parameter for indicating whether the PoC intersystem page message is for a PoC call.
